(19) United States
(12) Patent Application Publication
(10) Pub. No.: US 2018/0133942 A1
(43) Pub. Date: May 17, 2018

(54) RESIN MOLDING METHOD AND MOLDING DIE

(71) Applicant: HONDA MOTOR CO., LTD., Tokyo (JP)

(72) Inventors: Yosuke Ikadai, Tochigi (JP); Takashi Tsuchiya, Tochigi (JP); Masato Noguchi, Tochigi (JP)

(21) Appl. No.: 15/574,639

(22) PCT Filed: Jul. 5, 2016
(86) PCT No.: PCT/JP2016/069895

§ 371 Date: Nov. 16, 2017

(30) Foreign Application Priority Data
Aug. 26, 2015 (JP) 2015-167054

(51) Int. Cl. B29C 45/17; B29C 35/08; B29C 45/14

(52) U.S. Cl. CPC B29C 45/174; B60R 13/06; B29C 45/14418; B29C 35/0888

(57) ABSTRACT

A resin molding method for forming a resin molding (24) on a surface of a panel (1) includes: a molding die installation step of installing a molding die (3) formed of an elastic body on the panel (1) in such a manner as to form a cavity (7) by a molding face (10) thereof; a resistance increasing step of increasing resistance to pressure applied from the cavity (7) side with respect to the molding face (10); a resin injection step of injecting resin into the cavity (7); and a resin curing step of curing the injected resin.

### TECHNICAL FIELD

The present invention relates to a resin molding method for forming a resin molding on a surface of a panel, and a molding die suitable for the method.

### BACKGROUND ART

Heretofore, a side panel outer of an automobile has been produced by press molding a steel sheet, and stamping out openings. However, a side panel outer includes a large opening in parts corresponding to a front door and a rear door. Stamped-out steel sheets for creating the openings often turn into scrap, which leads to a problem of unavoidable yield reduction.

To solve the aforementioned problem, a side panel outer may be divided into two parts: upper and lower. In this case, for example, the side panel outer is divided at a lower end part of a front pillar, an upper part of a center pillar, and a lower end part of a rear pillar. This divides the side panel outer into an upper workpiece composed of the front pillar, a base part of an upper part of the center pillar, the rear pillar, and a quarter panel, and a lower workpiece composed of a lower part of the center pillar and a rocker panel.

Then, in the case of the upper workpiece, for example, the workpieces are arranged such that a protruding part (rear pillar and quarter panel) of one upper workpiece is placed inside a recessed part (space between center pillar and rear pillar, corresponding to front door and rear door) of the other upper workpiece. As a result, a large opening which is a part corresponding to a front door and a rear door can be utilized efficiently, so that the steel sheet is not wasted and yields can be improved.

When the side panel outer is divided into two pieces which are the upper workpiece and the lower workpiece, a gap is formed in a joint where the workpieces are joined. Hence, a seal needs to be formed to close the gap. In a known seal forming method, a sealer gun is held in a robot hand, and the sealer gun ejects to apply a sealing agent along the gap formed in the joint to form a seal (for example, see Patent Literature 1).

### CITATION LIST

### Patent Literature

Patent Literature 1: Japanese Utility Model Laid-Open No. H07-31166

### SUMMARY OF INVENTION

### Technical Problem

However, according to the above conventional technique, if there is a manufacturing error in the upper workpiece or the lower workpiece such error may have a direct adverse effect on the appearance or performance of the seal.

Assume a case where the height of the created seal is excessively higher than a surface of the upper workpiece or the lower workpiece, or where a seal face is formed at an excessively large angle with respect to the surface of the upper workpiece or the lower workpiece, when the upper workpiece and the lower workpiece form a center pillar or the like. In such case, it is concerned that the sealing property between the center pillar or the like and an automobile door when the door is in a closed state may deteriorate.

If the sealing agent is merely ejected from the sealer gun along the gap formed in the joint, shapes of parts of the applied sealing agent become uneven. Accordingly, there is an inconvenience that if the sealed joint is visible from the outside, sufficient appearance quality cannot be obtained. Hence, there is a need for a method of forming a resin molding as a seal on a surface of a panel as a workpiece in a desired shape, regardless of the manufacturing error of the panel.

In view of the above problems of the conventional technique, an objective of the present invention is to provide a resin molding method and a molding die that can form a resin molding having a desired shape on a surface of a panel, regardless of the manufacturing error of the panel.

### Solution to Problem

The first aspect of the invention is a resin molding method for forming a resin molding on a surface of a panel, the method including: a molding die installation step of installing a molding die configured of an elastic body on the panel in such a manner as to form a cavity between a molding face of the molding die and the surface of the panel; a resistance increasing step of increasing resistance to pressure applied from the cavity side to the molding face of the molding die installed in the molding die installation step; a resin injection step of, after the resistance increasing step, injecting resin into the cavity formed in the molding die installation step; and a resin curing step of curing the resin injected in the resin injection step.

According to the first aspect of the invention, when the molding die is installed on the surface of the panel in the molding die installation step, the molding face of the molding die follows the surface shape of the panel since the molding die is formed of an elastic body. After increasing the resistance to pressure applied from the cavity side to the molding face in the resistance increasing step, resin is injected into the cavity in the resin injection step.

Hence, when the resin is injected, resistance of the molding face has been increased, so that the shape of the molding face can be maintained against the pressure received from the resin. Accordingly, a resin molding having a desired shape can be formed regardless of the manufacturing error of the panel.

The second aspect of the invention is characterized in that of the first aspect of the invention, the resistance is increased by applying pressure on a face opposite to the molding face of a molding part that constitutes the molding face of the molding die.

According to the second aspect of the invention, since the resistance is increased by applying pressure on the face opposite to the molding face of the molding part, the resistance can be increased while avoiding influence on the shape of the molding face. Any method may be used to apply pressure on the face opposite to the molding face.

The third aspect of the invention is characterized in that of the second aspect of the invention, the resistance is increased by filling fluid in a filling space composed of the face opposite to the molding face of the molding part constituting the molding face of the molding die.

According to the third aspect of the invention, since the face opposite to the molding face of the molding part is evenly supported by the filled fluid, resistance of the molding face can be increased evenly.

The fourth aspect of the invention is characterized in that of any one of the first to third aspect of the inventions, the molding face of the molding die has a long shape corresponding to a joint of the panel and also has a cross section formed into an arch shape recessed toward the molding die, and the resin molding is formed to seal the joint of the panel.

According to the fourth aspect of the invention, since the cross section of the molding face of the molding die has an arched shape, when injecting resin into the cavity to form the long shaped resin molding for sealing the joint of the panel, pressure of the resin can be received evenly on the entire molding face.

The fifth aspect of the invention is characterized in that of any one of the first to fourth aspect of the inventions, the resin is photo-curable resin, the molding die is formed of a light-permeable material, and in the resin curing step, the resin is cured by being irradiated by light having passed through the molding die.

According to the fifth aspect of the invention, by selecting the timing at which to emit light on the resin, it is possible to cure the resin at an appropriate timing. Hence, the resin can be cured immediately after injection thereof into the cavity, to mold the resin promptly.

The sixth aspect of the invention is a molding die formed of an elastic body, the molding die comprising: a molding part that has a predetermined thickness, and forms a cavity between a panel by using a face of the molding part on one side in a thickness direction as a molding face to cover a part of a surface of the panel corresponding to a molding; and a seal part that is provided adjacent to the molding part, and is in close contact with the panel when forming the cavity to prevent leakage of resin injected into the cavity, wherein: the seal part has a wall face that faces and intersects with a face of the molding part on the other side in the thickness direction; and on a side of the face of the molding part on the other side, a filling space which is surrounded by the face and the wall face of the seal part and which can be filled with fluid, is provided.

According to the sixth aspect of the invention, since the molding die is formed of an elastic body, when forming a cavity with the panel, the molding face of the molding part can form the cavity while following the manufacturing error of the panel. By filling fluid into the filling space, resistance to pressure applied from the cavity side to the molding part can be increased. When filling the cavity with resin, this increase can prevent deformation of the molding face by pressure received from the resin. Hence, a resin molding having a desired shape can be formed on a surface of a panel, regardless of the manufacturing error of the panel.

The seventh aspect of the invention is characterized in that of the sixth aspect of the invention, the molding face has a length corresponding to a length of a joint of the panel to be arranged along the joint, and has an arch-shaped cross section.

According to the seventh aspect of the invention, by arranging the molding die such that the molding face covers the joint of the panel, a resin molding sealing the joint can be formed. At this time, when resin is injected into the cavity formed between the molding face and the panel, the arched shape of the molding face can even out the pressure applied on the molding face by resin, over the entire molding face.

The eighth aspect of the invention is characterized in that of any one of the sixth and seventh aspects of the invention further includes a plate that covers a part or all of the wall face of the seal part.

According to the eighth aspect of the invention, since the plate avoids application of pressure on the wall face of the seal part by the fluid filled in the filling space, deformation of the molding die by the pressure of the fluid can be prevented.

The ninth aspect of the invention is characterized in that of any one of the sixth to eighth aspects of the invention, the seal part has a thickness in a direction perpendicular to the wall face thereof, the thickness being thicker than a maximum thickness of the molding part.

According to the ninth aspect of the invention, since the molding part is thinner than the seal part, when placing the molding die on the surface of the panel, it can easily follow variation (manufacturing error) in the height of the panel around the molding part. Since the seal part is thicker than the molding part, it can favorably maintain its stiffness when pressed against the panel, and unintended deformation of the molding part can be prevented.

### BRIEF DESCRIPTION OF DRAWINGS

FIG. 1 is a perspective view of a molding die main body when a molding die of an embodiment of the present invention is placed on a joint of a panel.

FIG. 2 is a perspective view of the molding die that has the molding die main body of FIG. 1.

FIG. 3 is a diagram illustrating a cross section of the molding die of FIG. 2 and other components.

FIG. 4 is a cross-sectional view illustrating how the molding die is installed on the joint of the panel in a molding die installation step.

FIG. 5 is a perspective view illustrating an example of a resin molding formed in the joint of the panel by a resin molding method of the embodiment of the present invention.

### DESCRIPTION OF EMBODIMENTS

Hereinafter, an embodiment of the present invention will be described with reference to the drawings. The molding die of the embodiment is placed on a joint of a panel such as a side panel outer of an automobile, and is used to form a resin molding that seals the joint. FIG. 1 illustrates a molding die main body 2 of the molding die placed on the joint of a panel 1.

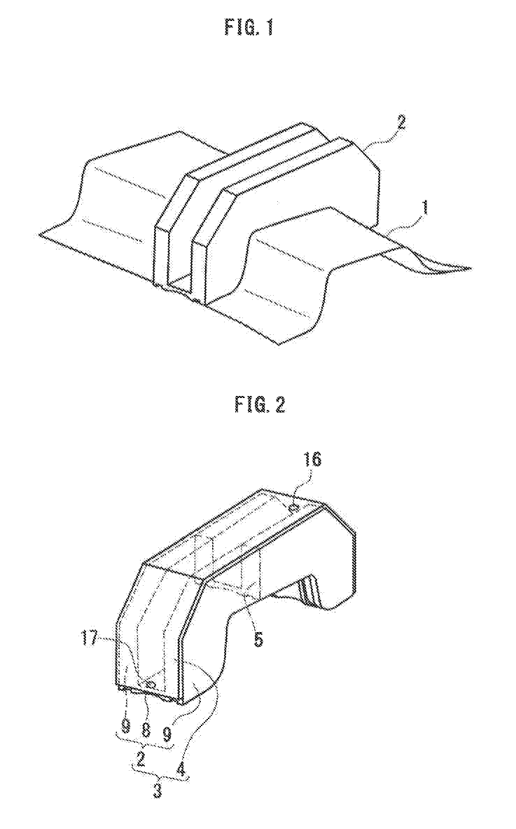

As illustrated in FIG. 2, a molding die 3 is composed of the molding die main body 2 formed of an elastic body, and a plate 4 that partially covers the molding die main body 2. A general silicone rubber such as KE-1310ST (product name) of Shin-Etsu Chemical Co., Ltd. may be used as the elastic body constituting the molding die main body 2.

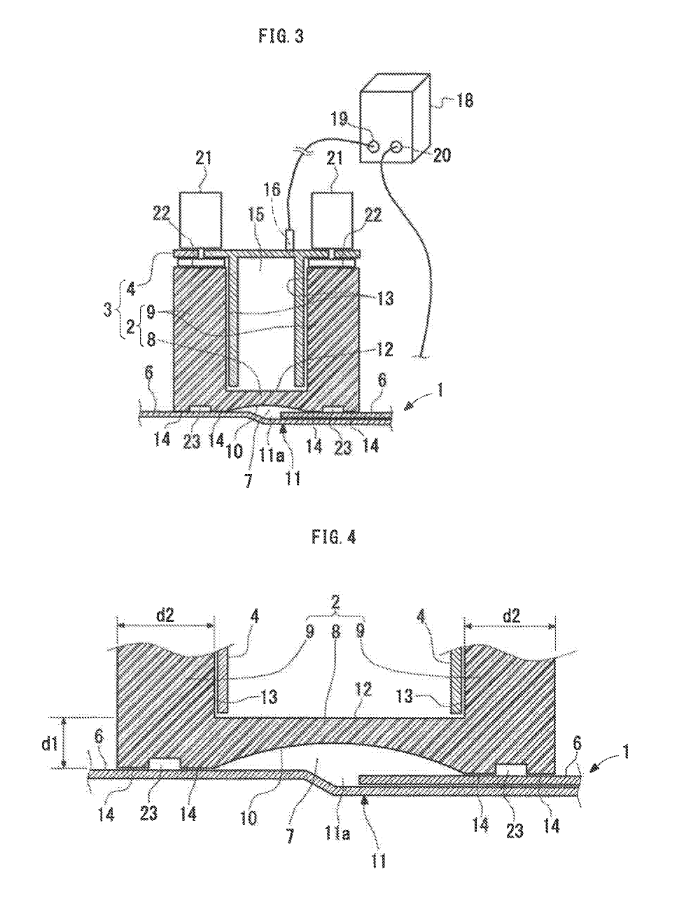

FIG. 3 is a cross-sectional view corresponding to a cross section 5 part of the molding die 3 of FIG. 2. As illustrated in FIG. 3, the molding die main body 2 comprises a molding part 8 that forms a cavity 7 with the panel 1 by covering a part on a surface 6 of the panel 1 corresponding to the molding, and seal parts 9 adjacent to both sides of the molding part 8.

As illustrated in FIG. 4, the molding part 8 has a predetermined thickness (maximum thickness) d1, and one face thereof in the thickness direction forms a curved molding face 10 constituting the cavity 7. To be placed along a joint 11 (more specifically, a gap 11a on the panel 1) of the panel 1, the molding face 10 has a length corresponding to the length of the joint 11, and its cross section has an arched shape recessed toward the molding part 8 side.

Each seal part 9 has a wall face 13 that is orthogonal to or intersects with a rear face 12, which is the other face of the molding part 8 in the thickness direction thereof. Each seal part 9 also has a thickness d2 in a direction perpendicular to the wall face 13, and the thickness d2 is larger than the thickness d1 of the molding part 8. Each seal part 9 is provided with a seal face 14 that is in close contact with the panel 1 when forming the cavity 7, to prevent leakage of resin injected into the cavity 7.

As illustrated in FIG. 2, the plate 4 covers a part of the molding die main body 2 extending from its upper face side to ends of the molding part 8 on both lateral face sides of the molding die main body 2 in the longitudinal direction. The plate 4 also covers the wall face 13 of each seal part 9, and forms, with the rear face 12 of the molding part 8, a filling space 15 that can be filled with an incompressible fluid as illustrated in FIG. 3. In other words, the filling space 15 surrounded by the rear face 12 and the wall faces 13 of the seal parts 9 is provided on the rear face 12 side of the molding part 8. The plate 4 may partially cover the part of the molding die main body 2 extending from its upper face side to ends of the molding part 8 on both lateral face sides of the molding die main body 2 in the longitudinal direction.

As illustrated in FIG. 2, the plate 4 has, in an upper part thereof, an inlet 16 for filling the filling space 15 with the incompressible fluid, and has, in a lowermost part thereof, an outlet 17 for discharging the incompressible fluid.

As illustrated in FIG. 3, a feed port 19 of an incompressible fluid-injection unit 18 is connected to the inlet 16, and a recovery port 20 of the injection unit 18 is connected to the outlet 17. Water or industrial oil is used as the incompressible fluid.

A pressurized face 22 pressurized by an air cylinder 21 is provided on a top face of the seal part 9. By pressurizing the pressurized face 22 by the air cylinder 21, the seal face 14 is pressed against the panel 1 to prevent the resin inside the cavity 7 from leaking from between the seal part 9 and the panel 1.

A recessed groove 23 is formed in the seal face 14 along the longitudinal direction thereof. The groove 23 has a function of increasing bearing stress when pressing the seal face 14 against the panel 1, to improve the sealing property of the seal face 14.

Photo-curable resin is used as the resin used to form the resin molding. The molding die main body 2, the plate 4, and the incompressible fluid are formed of light-permeable materials, so that the resin filling the cavity 7 can be irradiated with light and be cured.

In this configuration, the resin molding is formed on the surface of the panel by performing the following molding die installation step, resistance increasing step, resin injection step, and resin curing step.

(1) In the molding die installation step, the molding die 3 is installed on the panel 1 in such a manner as to form the cavity 7 between the molding face 10 and the surface of the panel 1. As illustrated in FIG. 4, the molding die 3 is installed such that the molding face 10 covers the joint 11 of the panel 1 around the gap 11a as the center, and the seal face 14 of the seal part 9 is in close contact with the surface of the panel 1. To ensure the close contact with the panel 1, the pressurized face 22 on the top face of the seal part 9 is pressurized by the air cylinder 21.

At this time, since the molding die main body 2 is an elastic body, the seal face 14 adheres onto the surface of the panel 1 while favorably following unexpected variation caused by manufacturing errors of the shape of the surface. Additionally, even when there is a degree of step difference or deviation caused by manufacturing error between a part of the panel 1 on one side of the joint 11 and a part of the panel 1 on the other side thereof, the molding part 8 which is thinner than the seal part 9 can cover the joint 11 while favorably following such a step difference or the like.

(2) In the resistance increasing step, bearable pressure (resistance to pressure applied on molding face 10 from cavity 7 side) of the molding face 10 of the installed molding die 3 is increased. This pressure is increased by filling the filling space 15 of the molding die 3 with incompressible fluid by the injection unit 18. When the filling is completed, input or output of the incompressible fluid into or from the filling space 15 is prevented until the resin injected into the cavity 7 cures completely.

Thus, the molding face 10 is evenly and firmly supported from the molding part 8 side by the incompressible fluid filled therein, and is protected so that it is hardly deformed even when pressure is applied from the cavity 7 side.

(3) In the resin injection step, resin is injected into the cavity 7 formed in the aforementioned (1) molding die installation step. Photo-curable resin is used as the injected resin. The resin is injected from an opening on one side of the cavity 7, which is open on both ends of the molding die 3, until the resin reaches the other opening.

While the molding face 10 receives pressure from the injected resin at this time, its arched cross section evens out the value of pressure over the entire molding face 10. Since the molding face 10 is protected in the aforementioned resistance increasing step, it is not deformed by the pressure of the resin. Additionally, since the seal face 14 of the seal part 9 is in close contact with the surface of the panel 1 as mentioned earlier, the resin does not leak from between the seal face 14 and the surface of the panel 1.

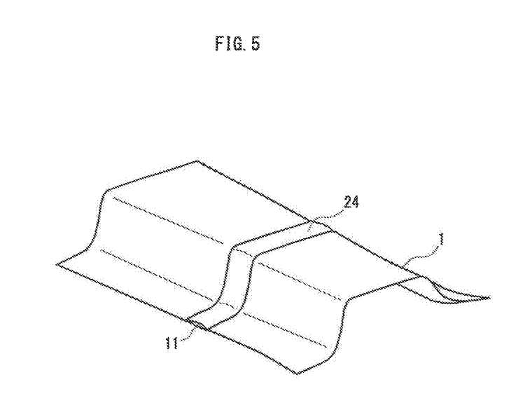

(4) In the resin curing step, the resin injected in the aforementioned (3) resin injection step is cured. Specifically, the photo-curable resin inside the cavity 7 is irradiated with light through the molding die 3 and the incompressible fluid formed of light-permeable materials, and is thereby cured. Thus, a resin molding 24 covering the joint 11 of the panel 1 as illustrated in FIG. 5 is formed.

As has been described, according to the present embodiment, the molding die 3 is formed of an elastic body, and therefore can be installed on the panel 1 while allowing the molding face 10 to follow the varied (manufacturing error) surface shape of the panel 1. Since resin is injected into the cavity 7 after increasing the bearable pressure of the molding face 10 in the resistance increasing step, the shape of the molding face is maintained against the pressure received from the resin. Hence, it is possible to form the resin molding 24 having a desired shape following the surface shape of the panel 1.

For example, assume a case where the panel 1 constitutes a center pillar or the like, and the resin molding is formed as a sealer of its joint. In this case, the shape and dimension of the resin molding are limited to prevent reduction in the sealing property between the center pillar or the like and the door in a door closed state, or to prevent degradation in appearance when the door is opened. The embodiment can deal with these limitations effectively.

Since the bearable pressure of the molding face 10 is increased by filling the filling space 15 with fluid, the bearable pressure can be increased evenly over the entire molding face 10. Additionally, since the fluid is incompressible, the molding face 10 can surely bear the pressure from the resin inside the cavity 7, and maintain its shape.

Since the cross section of the molding face 10 has an arched shape, it can receive pressure of resin upon injection thereof into the cavity 7, evenly on the entire molding face 10.

Since photo-curable resin is used as the resin injected into the cavity 7, and the molding die 3 and other components are formed of light-permeable materials, the resin can be cured immediately after injection thereof, to promptly form the resin molding.

By having the plate 4 covering the wall face 13 of the seal part 9, it is possible to prevent the fluid filling the filling space 15 from applying pressure on the wall face 13 and deforming the molding die 3.

Since the molding part 8 is thinner than the seal part 9, it can easily follow variation in height of the panel 1 in a direction perpendicular to the longitudinal direction of the molding part 8. Meanwhile, since the seal part 9 is thicker than the molding part 8, it can favorably maintain its shape by its stiffness, when pressed against the panel 1.

Note that the present invention is not limited to the embodiment. For example, as the fluid filling the filling space 15, compressible fluid such as air or the like may be used instead of the incompressible fluid. Other substances such as powder and semifluid may fill the filling space 15. As a unit to pressurize the pressurized face 22 on the top face of the seal part 9, other pressurizing units may be used instead of the air cylinder 21.

The invention is not limited to the joint 11 of the panel 1, and is also applicable to a case of forming a resin molding on another part of the panel 1. As a method of increasing bearable pressure (resistance to pressure applied on molding face 10 from cavity 7 side) of the molding face 10 in the resistance increasing step, the rear face 12 of the molding face 10 of the molding part 8 may be pushed instead of filling the filling space 15 with fluid. Another configuration to apply force directed toward the molding face 10 to a magnet buried in the molding part 8 by energizing a coil arranged opposite to the molding face 10, may b used.

The cross-sectional shape of the curved molding face 10 constituting the cavity 7 is not limited to the arched shape, and may be other curved shapes such as a shape in which multiple arch shapes are arranged or a corrugated shape.

The widths of the rear face 12 and the molding face 10 of the molding part 8 do not need to be the same, and the width of the rear face 12 may either be larger or smaller than the width of the molding face 10.

### REFERENCE SIGNS LIST

1 . . . panel, 2 . . . molding die main body, 3 . . . molding die, 4 . . . plate, 7 . . . cavity, 9 . . . seal part, 10 . . . molding face, 11 . . . joint, 12 . . . rear face, 13 . . . wall face, 14 . . . seal face, 15 . . . filling space, 16 . . . inlet, 17 . . . outlet, 18 . . . injection unit, 19 . . . feed port, 20 . . . recovery port, 21 . . . air cylinder, 22 . . . pressurized face, 23 . . . groove, 24 . . . resin molding.

1. A resin molding method for forming a resin molding on a surface of a panel, the method comprising:
a molding die installation step of installing a molding die configured of an elastic body on the panel in such a manner as to form a cavity between a molding face of the molding die and the surface of the panel;
a resistance increasing step of increasing resistance to pressure applied from the cavity side to the molding face of the molding die installed in the molding die installation step;
a resin injection step of, after the resistance increasing step, injecting resin into the cavity formed in the molding die installation step; and
a resin curing step of curing the resin injected in the resin injection step.

2. The resin molding method according to claim 1, wherein
the resistance is increased by applying pressure on a face opposite to the molding face of a molding part that constitutes the molding face of the molding die.

3. The resin molding method according to claim 2, wherein
the resistance is increased by filling, with fluid, a filling space composed of the face opposite to the molding face of the molding part constituting the molding face of the molding die.

4. The resin molding method according to claim 1, wherein:
the molding face has a long shape corresponding to a joint of the panel and also has a cross section formed into an arch shape recessed toward the molding die; and
the resin molding is formed to seal the joint of the panel.

5. The resin molding method according to claim 1, wherein:
the resin is photo-curable resin;
the molding die is formed of a light-permeable material; and
in the resin curing step, the resin is cured by being irradiated by light having passed through the molding die.

6. A molding die formed of an elastic body, the molding die comprising:
a molding part that has a predetermined thickness, and forms a cavity between a panel by using a face of the molding part on one side in a thickness direction as a molding face to cover a part of a surface of the panel corresponding to a molding; and
a seal part that is provided adjacent to the molding part, and is in close contact with the panel when forming the cavity to prevent leakage of resin injected into the cavity, wherein:
the seal part has a wall face that faces and intersects with a face of the molding part on the other side in the thickness direction; and
on a side of the face of the molding part on the other side, a filling space which is surrounded by the face and the wall face of the seal part and which can be filled with fluid, is provided.

7. The molding die according to claim 6, wherein
the molding face has a length corresponding to a length of a joint of the panel to be arranged along the joint, and has an arch-shaped cross section.

8. The molding die according to claim 6, further comprising a plate that covers a part or all of the wall face of the seal part.

9. The molding die according to claim 6, wherein
the seal part has a thickness in a direction perpendicular to the wall face thereof, the thickness being thicker than a maximum thickness of the molding part.
